(19) United States
(12) Patent Application Publication
(10) Pub. No.: US 2011/0029377 A1
(43) Pub. Date: Feb. 3, 2011

(54) SYSTEM AND METHOD FOR FORECASTING AN INVENTORY OF ONLINE ADVERTISEMENT IMPRESSIONS BY SAMPLING IN A MAP-REDUCE FRAMEWORK

(75) Inventors: Peiji Chen, Saratoga, CA (US); Wei Li, Sunnyvale, CA (US); Srinivasan Rajagopal, San Jose, CA (US); Erik Vee, San Mateo, CA (US); Jack Z. Xie, San Francisco, CA (US); Sheng Zhang, Mountain View, CA (US)

Correspondence Address: Michael Buchenhorner P.A., 8540 SW 83 Street, Miami, FL, 33143, US

(73) Assignee: Yahoo! Inc., Sunnyvale, CA (US)

(21) Appl. No.: 12/512,986

(22) Filed: Jul. 30, 2009

(51) Int. Cl. G06Q 30/00

(52) U.S. Cl. 705/14.45; 705/14.52

(57) ABSTRACT

An improved system and method for forecasting an inventory of online advertisement impressions by sampling in a map-reduce framework is provided. In a map-reduce framework, samples of visitor profiles may be collected and matched to targeting profiles for displaying advertisements by distributed sample mappers. Sets of samples of visitor profiles matched to the targeting profiles may be mapped and distributed to reducer servers for integrating the samples collected by sample mappers into a reduction sample set for each targeting profile. Each reducer server may aggregate a count of samples of visitor profiles matched to a targeting profile, and the sets of samples of visitor profiles matched to a targeting profile may be integrated into a reduction sample set for each targeting profile. The sample reducers may forecast a targeting profile inventory for each targeting profile and output the targeting profile inventory with a reduction sample set of visitor profiles.

### FIELD OF THE INVENTION

The invention relates generally to computer systems, and more particularly to an improved system and method for forecasting an inventory of online advertisement impressions by sampling in a map-reduce framework.

### BACKGROUND OF THE INVENTION

A major problem faced by an online advertising publisher is to forecast available inventory of advertisement impressions for sale to online advertisers. Online advertisers would like to target users visiting certain web pages with certain demographics, geographies, behavioral interests, as well as many other attributes. For example, an advertiser may want to target users in a publisher's website with the following profile: male, over 25 years old, with a behavioral interest in automobiles. Thus an online advertising publisher needs to make accurate forecasts for any combination of those attributes efficiently.

One method of forecasting available inventory of advertisement impressions for sale to online advertisers that are untargeted is described in U.S. Pat. No. 6,801,945, entitled “SYSTEMS AND METHODS FOR PREDICTING TRAFFIC ON INTERNET SITES”. However, the problem of forecasting available inventory of advertisement impressions for sale to online advertisers for targeting profiles of attributes is complicated by the fact that there may be thousands of targeting attributes. Moreover, online advertising applications may need to forecast advertisement impression inventory from hundreds of gigabytes of advertisement impression data collected daily. The greater the number of advertising properties managed by the online publisher, the more complicated the problem becomes to forecast the thousands of targeting attributes across the advertising properties.

What is needed is a way for an online publisher to efficiently forecast available inventory of online advertisement impressions for targeting profiles of attributes. Such a system and method should be able to make accurate forecasts for any combination of those attributes.

### SUMMARY OF THE INVENTION

Briefly, the present invention may provide a system and method for forecasting an inventory of online advertisement impressions by sampling in a map-reduce framework. In an embodiment of a map-reduce framework for sampling online advertisement impressions, one or more sample mappers each executing on one or more servers may be operably coupled to one or more sample reducers each executing on one or more reducer servers in a distributed computer system. A sample mapper may receive targeting profiles of attributes for displaying advertisements and may collect samples of profiles of visitors served impressions of advertisements from impression logs. The samples of visitor profiles collected may be matched to the targeting profiles for displaying advertisements. Each of the targeting profiles may be mapped to a reducer server for integrating the samples collected by each of the one or more sample mappers executing on each of the servers into a reduction sample set for a targeting profile. The or more sample mappers may send the collected samples of visitor profiles matched to targeting profiles to the one or more mapped reducer servers for integrating the samples collected by each of the one or more sample mappers into a reduction sample set for a targeting profile.

One or more sample reducers each executing on one or more reducer servers may receive sets of samples of visitor profiles matched to a targeting profile for integration into a reduction sample set. A count of samples of visitor profiles matched to a targeting profile may be aggregated by a sample reducer for a targeting profile, and the sets of samples of visitor profiles matched to a targeting profile may be integrated into a reduction sample set for each targeting profile. In an embodiment, a multitude of sample sets may be integrated into a uniformly distributed reduction sample set for each of the targeting profiles. The one or more sample reducers may forecast a targeting profile inventory for each targeting profile from the aggregated count of samples of visitor profiles matched to the targeting profile. And a targeting profile inventory may be output by a sample reducer with a reduction sample set of visitor profiles for the targeting profile.

Advantageously, the present invention may accurately forecast an inventory of advertisement impressions for online advertising. By providing a map-reduce framework for sampling online advertisement impressions, the present invention may be scalable for online advertising applications that may forecast advertisement impression inventory from hundreds of gigabytes of advertisement impression data collected daily. Samples of visitor profiles matched to a targeting profile may be collected in parallel across multiple machines and reduced into a sample set representing a uniform distribution in parallel by multiple reducer servers.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for forecasting an inventory of online advertisement impressions for targeting profiles of attributes by sampling in a map-reduce framework, in accordance with an aspect of the present invention;

FIG. 3 is a flowchart for generally representing the steps undertaken in one embodiment for forecasting an inventory of online advertisement impressions by sampling in a map-reduce framework, in accordance with an aspect of the present invention;

FIG. 4 is a flowchart for generally representing the steps undertaken in one embodiment by a sample mapper for forecasting an inventory of online advertisement impressions by sampling in a map-reduce framework, in accordance with an aspect of the present invention;

FIG. 5 is a flowchart for generally representing the steps undertaken in one embodiment by a sample reducer executing on a reducer server for forecasting an inventory of online advertisement impressions by sampling in a map-reduce framework, in accordance with an aspect of the present invention; and

FIG. 6 is a flowchart for generally representing the steps undertaken in one embodiment by a sample reducer executing on a reducer server for integrating the sets of samples of visitor profiles matched to a targeting profile into a reduction sample set for the targeting profile, in accordance with an aspect of the present invention.

### DETAILED DESCRIPTION

### Exemplary Operating Environment

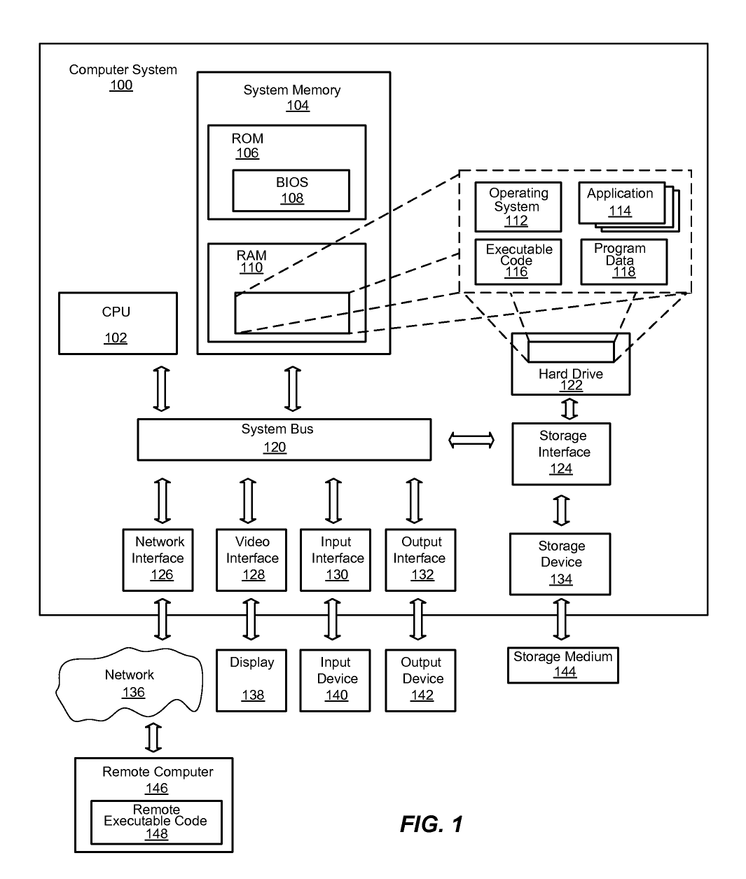

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Forecasting An Inventory of Online Advertisement Impressions by Sampling in a Map-Reduce Framework

The present invention is generally directed towards a system and method for forecasting an inventory of online advertisement impressions for targeting profiles of attributes by sampling in a map-reduce framework. As used herein, a targeting profile of attributes means one or more attributes associated with web page properties, with web browser properties, with one or more users including demographics, online behavior, and so forth. A map-reduce framework may support an implementation of a task that may separated into a map phase and a reduce phase. Sample mappers distributed on servers may collect and match samples of visitor profiles of attributes to targeting profiles of attributes. Sets of samples of visitor profiles matched to the targeting profiles may be mapped and distributed to reducer servers to integrate the samples collected by sample mappers into a reduction sample set for each targeting profile. The sample reducers may forecast a targeting profile inventory for each targeting profile and output the targeting profile inventory with a reduction sample set of visitor profiles. In an embodiment, the targeting profile inventory may be an inventory forecast of advertisement impressions available on display advertising properties during a time period. As used herein, a display advertising property means a collection of related web pages that may have advertising space allocated for displaying advertisements. As used herein, a reduction sample set means a sample set generated from integrating a subset of samples from sets of samples.

As will be seen, a forecast of an inventory of online advertisement impressions may be generated to target many different profiles of attributes. Thus, the present invention may provide a publisher with the capability to forecast available inventories of advertisement impressions for targeting different combinations of attributes before selling them to online advertisers. As will be understood, the various block diagrams, flow charts and scenarios described herein are only examples, and there are many other scenarios to which the present invention will apply.

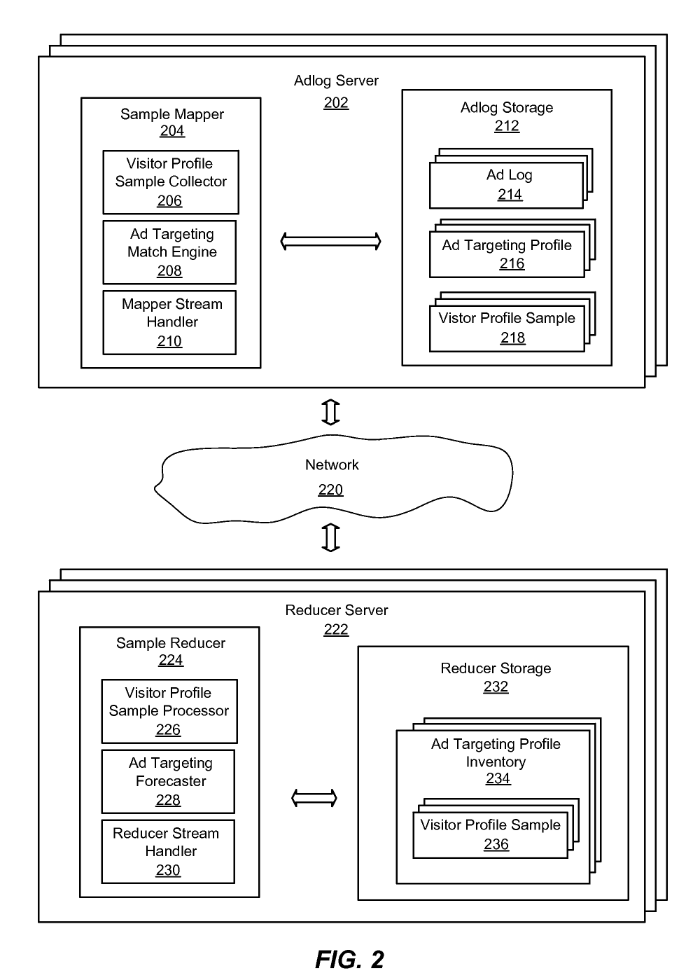

Turning to FIG. 2 of the drawings, there is shown a block diagram generally representing an exemplary architecture of system components for forecasting an inventory of online advertisement impressions for targeting profiles of attributes by sampling in a map-reduce framework. Those skilled in the art will appreciate that the functionality implemented within the blocks illustrated in the diagram may be implemented as separate components or the functionality of several or all of the blocks may be implemented within a single component. For example, the functionality for the mapper stream handler 210 may be included as a component of the sample mapper 204. Or the functionality of the mapper stream handler 210 may be implemented as a separate component. Moreover, those skilled in the art will appreciate that the functionality implemented within the blocks illustrated in the diagram may be executed on a single computer or distributed across a plurality of computers for execution.

In various embodiments, one or more ad log servers 202 may be operably coupled to one or more reducer servers 222 by a network 220. The ad log server 202 and the reducer server 222 may each be a computer such as computer system 100 of FIG. 1. The network 220 may be any type of network such as a local area network (LAN), a wide area network (WAN), or other type of network. The ad log server 202 may include functionality for receiving ad targeting profiles, collecting samples of profiles of visitors served impressions of advertisements that are stored in ad logs 214 on the ad log server 202, matching the samples of visitor profiles to ad targeting profiles, and sending representative samples of visitor profiles that match ad targeting profiles to a reducer server 222 for integrating representative samples of visitor profiles from various ad log servers to forecast the targeting profile inventory of advertisements for each targeting profile. The ad log server 202 may be operably coupled to a computer-readable storage medium such as ad log storage 212 that may store one or more ad logs 214 of historical impressions of advertisements served to visitors of web pages, one or more ad targeting profiles 216, and one or more samples of visitor profiles 218 served impressions of advertisements.

The ad log server 202 may include a sample mapper 204 that receives various ad targeting profiles, collects samples of visitor profiles, matches the samples of visitor profiles to ad targeting profiles, and outputs sets of visitor profile samples for each of the various ad targeting profiles. The sample mapper 204 may include a visitor profile sample collector 206 that collects samples of profiles of visitors served impressions of advertisements that are stored in ad logs 214 on the ad log server 202. The sample mapper 204 may also include an ad targeting match engine 208 that matches the samples of visitor profiles 218 to ad targeting profiles 216. And the sample mapper 204 may additionally include a mapper stream handler 210 that maps the targeting profiles to reducer servers 222 and sends representative samples of visitor profiles that match ad targeting profiles to a mapped reducer server 222. Each of these components may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The reducer server 222 may include functionality for receiving sets of samples of visitor profiles matched to a targeting profile, aggregating a count of samples of visitor profiles matched to a targeting profile, integrating sets of samples of visitor profiles matched to a targeting profile, and forecasting the targeting profile inventory from the aggregated count of samples of visitor profiles matched to a targeting profile. The reducer server 222 may be operably coupled to a computer-readable storage medium such as reducer storage 232 that may store one or more ad targeting profile inventories 234 that include a reduction sample set of representative visitor profile samples 236.

The reducer server 222 may include a sample reducer 224 that receives one or more sets of samples of visitor profiles matched to a targeting profile, forecasts a targeting profile inventory from the one or more sets of samples of visitor profiles matched to a targeting profile, and outputs a targeting profile inventory with a reduction sample set of visitor profiles for the targeting profile. The sample reducer 224 may include a visitor profile sample processor 226 that aggregates a count of samples of visitor profiles matched to a targeting profile and integrates sets of samples of visitor profiles matched to a targeting profile. The sample reducer 224 may also include an ad targeting forecaster 228 that forecasts the targeting profile inventory from the aggregated count of samples of visitor profiles matched to a targeting profile. The sample reducer 224 may additionally include a reducer stream handler 230 that receives one or more sets of samples of visitor profiles matched to a targeting profile. Each of these components may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

There are many applications that may use the present invention to forecast inventory for displaying advertisement impressions. For instance, the present invention may be used to determine untargeted inventory for displaying advertisement impressions to online users. Or the present invention may be used to forecast targeting profile inventory for displaying advertisement impressions. For example, an application may send a request to obtain an inventory forecast of available advertisement impressions for targeting profiles of attributes. In an embodiment, the ad logs 224 may include recorded information of advertisement impressions served. The recorded information may include a web page ID, a user ID, an advertisement ID, a timestamp, and other information such as a web browser ID. The information gathered from the logs and other lookup tables, such as page hierarchy tables and visitor attribute tables, may include web page attributes such as properties of the page and the web page position of an advertisement; visitor attributes such as age, gender, country, behavioral interests; time attributes such as date and hour of the day; and other attributes such as attributes of a browser. Samples of visitor profiles that include visitor attributes may be collected from the ad logs on a multitude of ad log servers, may be matched to a targeting profile, and may be sent to mapped reducer servers that forecast a targeting profile inventory from sets of samples of visitor profiles matched to a targeting profile. The forecast of the targeting profile may then be sent as a response to the application request for an inventory forecast of available advertisement impressions for targeting profiles of attributes.

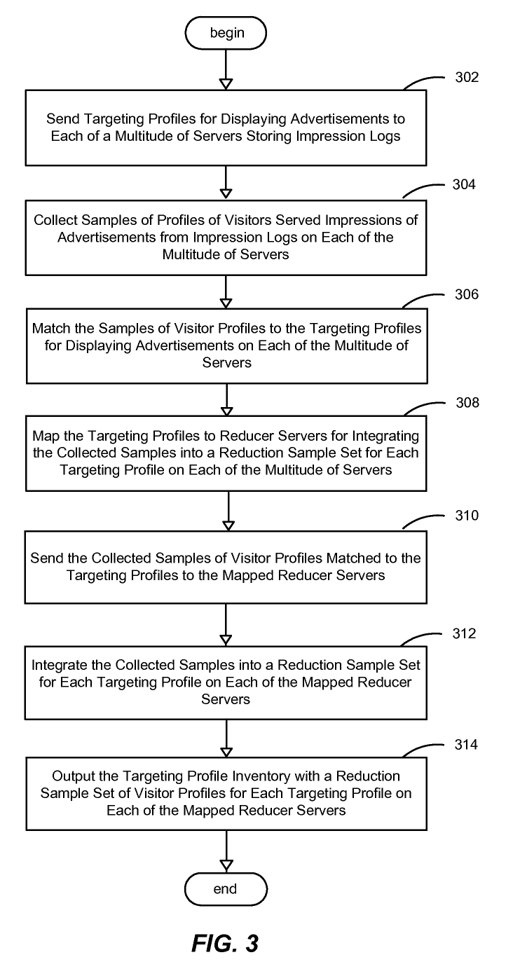

FIG. 3 presents a flowchart for generally representing the steps undertaken in one embodiment for forecasting an inventory of online advertisement impressions by sampling in a map-reduce framework. At step 302, targeting profiles for displaying advertisements may be sent to each of a multitude of servers storing log files of historical impressions of advertisements served to online users. For instance, an application executing on a server may send targeting profiles from advertisement contracts for displaying advertisements to a targeting profile of attributes. At step 304, samples of profiles of visitors served impressions of advertisements may be collected from ad logs, or impression logs, on each of a multitude of servers. To save storage and computation time, a uniform distribution of samples may be extracted from the impression logs that may be used to generate a forecast of inventory of advertisement impressions for targeting profiles of attributes. In various embodiments, random samples may be collected as historical impressions of advertisements served to online users are recorded in the impression logs. At step 306, the samples of visitor profiles collected may be matched to the targeting profiles for displaying advertisements. In general, a targeting profile may be defined by attributes such as time attributes, user behavior attributes, web page attributes and so forth. In an embodiment, samples of visitor profiles collected that match a targeting profile may share the same attributes, such as web page attributes including properties of the web page and the web page position of an advertisement, visitor attributes such as age, gender, country, behavioral interests, time attributes such as date and hour of the day, and other attributes such as attributes of a browser.

At step 308, each of the targeting profiles may be mapped to a reducer server for integrating the samples collected on each of the multitude of servers into a reduction sample set for a targeting profile. In an embodiment, an index may be constructed of targeting profile identifiers with each having an associated address of a reducer server. This index may be sent to the multitude of servers. At step 310, the multitude of servers may send the collected samples of visitor profiles matched to targeting profiles to the mapped reducer servers for integrating the samples collected on each of the multitude of servers into a reduction sample set for a targeting profile. At step 312, each reducer server may integrate the samples received from each of the multitude of servers into a reduction sample set for a targeting profile. In various embodiments, a number of samples proportional to the number received and processed may be randomly selected for including into the reduction sample set for the targeting profile. In various other embodiments, random samples may be uniformly selected from samples received for including into the reduction sample set for the targeting profile. And step 314, a targeting profile inventory may be output with a reduction sample set of visitor profiles for each of the targeting profiles by the reducer servers.

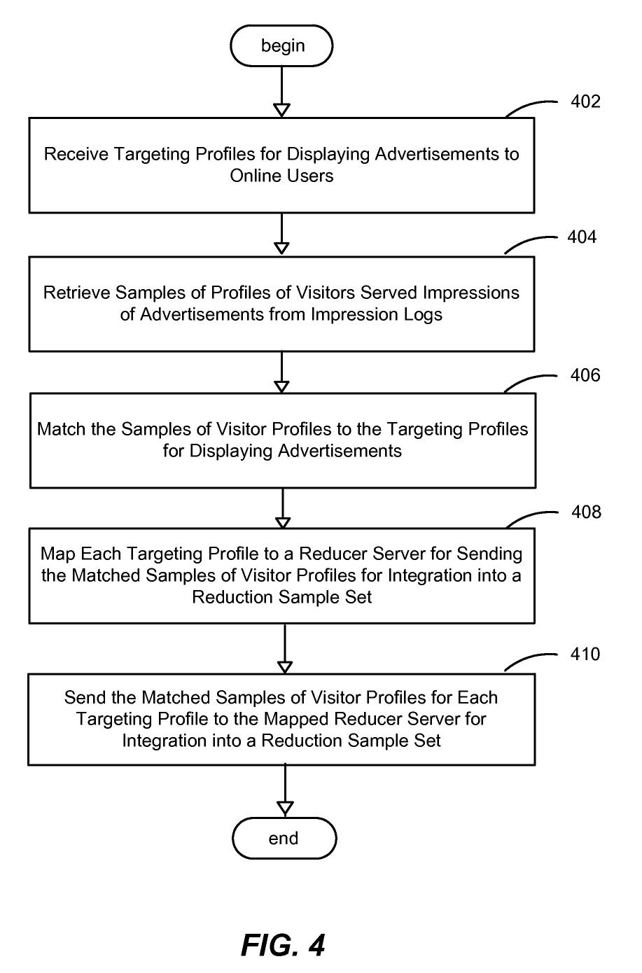

FIG. 4 presents a flowchart for generally representing the steps undertaken in one embodiment by a sample mapper for forecasting an inventory of online advertisement impressions by sampling in a map-reduce framework. At step 402, targeting profiles for displaying advertisements to online visitors may be received by a sample mapper. At step 404, samples of profiles of visitors served advertisement impressions may be retrieved by a sample mapper from impression log files. In an embodiment, a randomly selected sample of profiles of visitors may be retrieved. In various embodiments, samples may be collected at the time an entry is made into an impression log file to record display of an advertisement impression. At step 406, the samples of visitor profiles may be matched to the targeting profiles for displaying advertisements to online visitors.

Each targeting profile may be mapped at step 408 by a sample mapper to a reducer server for sending the matched samples of visitor profiles for integration into a reduction sample set. In an embodiment, a single reducer server may be designated for integrating sample sets of visitor profiles from a multitude of sample mappers for a targeting profile. At step 410, samples of visitor profiles matched to a targeting profile may be sent to the mapped reducer server by a sample mapper for each of the targeting profiles for integration into a reduction sample set.

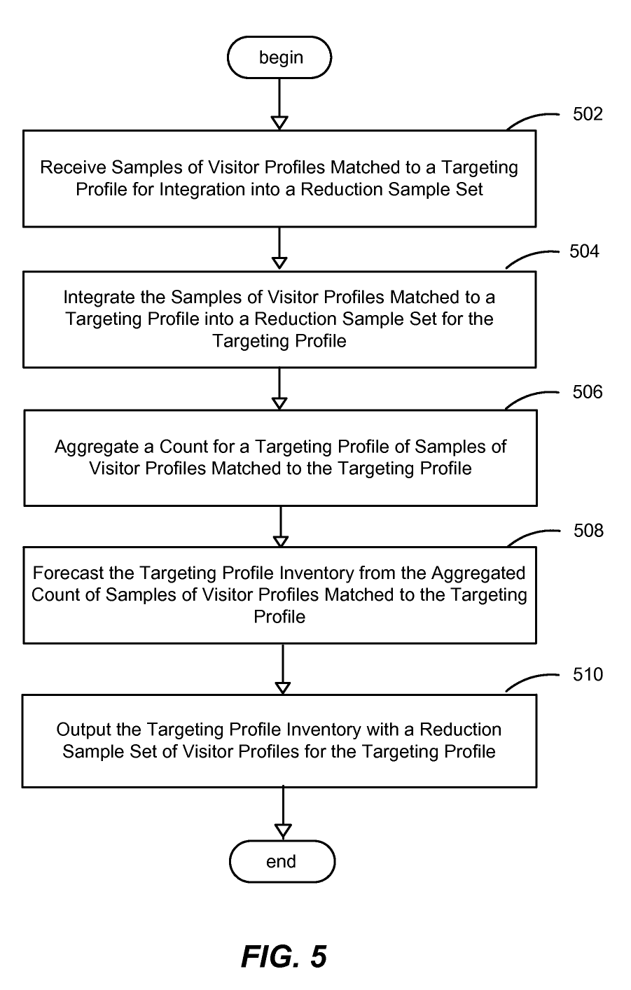

FIG. 5 presents a flowchart for generally representing the steps undertaken in one embodiment by a sample reducer executing on a reducer server for forecasting an inventory of online advertisement impressions by sampling in a map-reduce framework. At step 502, sets of samples of visitor profiles matched to a targeting profile may be received by a sample reducer for a targeting profile for integration into a reduction sample set. At step 504, the sets of samples of visitor profiles matched to a targeting profile may be integrated into a reduction sample set for the targeting profile. In an embodiment, a multitude of sample sets of the same or different sizes may be integrated into a uniformly distributed reduction sample set of a given size for each of the targeting profiles. At step 506, a count of samples of visitor profiles matched to a targeting profile may be aggregated by a sample reducer for a targeting profile. At step 508, a targeting profile inventory may be forecast by a sample reducer from the aggregated count of samples of visitor profiles matched to the targeting profile. And at step 510, a targeting profile inventory may be output by the sample reducer with a reduction sample set of visitor profiles for the targeting profile.

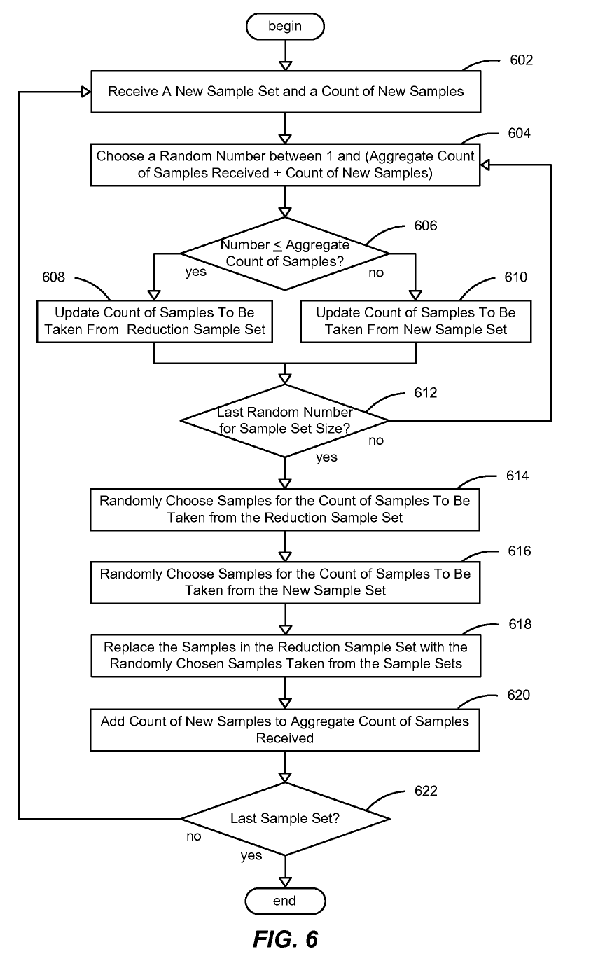

FIG. 6 presents a flowchart for generally representing the steps undertaken in one embodiment by a sample reducer executing on a reducer server for integrating the sets of samples of visitor profiles matched to a targeting profile into a reduction sample set for the targeting profile. In an embodiment, a multitude of sample sets of the same or different sizes may be integrated into a uniformly distributed reduction sample set of a given size for each of the targeting profiles. In general, random samples may be uniformly chosen from the existing reduction sample set and the new sample set to replace the samples in the reduction sample set, and an aggregate count of samples received for a multitude of sample sets may be updated upon integrating each new sample set received into a reduction sample set. To do so, S random numbers, where S is the given size of the reduction sample set for a targeting profile, may be chosen from the range of 1 to N, where N is the sum of the aggregate count of samples received plus the size of the new sample set. As each of the S random numbers are uniformly chosen from the two sets, a count of samples to be taken from the reduction sample set and a count of samples to be taken from the new sample set are updated in an embodiment. And samples are randomly chosen from the reduction sample set for the count of samples to be taken from the reduction sample set, and samples are randomly chosen from the new sample set for the count of samples to be taken from the new sample set.

At step 602, a new sample set and a count of new samples may be received. In various embodiments, a reducer server may receive the new sample set and the count of new samples from one of multiple servers. For the first sample set of a multitude of sample sets received by the reducer server for the targeting profile, the samples from the first sample set may be stored into an empty reduction sample set and an aggregate count of samples received may be set to zero. At step 604, a random number may be chosen between 1 and the sum of an aggregate count of samples received and the count of the new samples. It may then be determined at step 606 whether the random number chosen may be less than or equal to the aggregate count of samples received. If the random number chosen may be less than or equal to the aggregate count of samples received, then a count of samples to be taken from the reduction sample set may be updated at step 608 by incrementing the count by one. Otherwise, if the random number chosen may be greater than the aggregate count of samples received, then a count of samples to be taken from the new sample set may be updated at step 610 by incrementing the count by one.

At step 612, it may be determined whether the last random number for the given sample reduction set size has been chosen. If not, then processing may continue at step 604 where a random number may be chosen between 1 and the sum of an aggregate count of samples received and the count of the new samples. Otherwise, if it may be determined that the last random number for the given sample reduction set size has been chosen at step 612, then samples are randomly chosen from the reduction sample set for the count of samples to be taken from the reduction sample set at step 614. At step 616, samples are randomly chosen from the new sample set for the count of samples to be taken from the new sample set. And at step 618, the samples in the reduction sample set may be replaced by the samples randomly chosen from the reduction sample set at step 614 and the samples randomly chosen from the new sample set at step 616.

At step 620, the count of new samples may be added to the aggregate count of samples received. It may be determined at step 622 whether the last sample set has been received for integrating the sets of samples into a reduction sample set. If not, then processing may continue at step 602 where a new sample set and count of samples may be received. Otherwise, if it may be determined that the last sample set has been received, then processing may be finished for integrating the sets of samples into a reduction sample set.

Because online advertising applications may forecast advertisement impression inventory from hundreds of gigabytes of advertisement impression data collected daily, those skilled in the art will appreciate that the steps described in conjunction with FIG. 6 may also be used by a sample mapper executing on an ad log server for integrating samples of visitor profiles matched to a targeting profile into a sample set of a fixed size for a targeting profile.

Importantly, the forecast of an inventory of online advertisement impressions may be generated to target many different profiles. For instance, web page attributes such as properties of the page and the web page position of an advertisement may be used. User attributes for online behavior and/or demographics including age, gender, and country, may be used for targeting profiles of attributes. Or profiles of attributes may be targeted by time, browser attribute or type, and so forth. The present invention may make accurate forecast for any combination of thousands of targeting attributes. Thus, the present invention may provide an online publisher with the capability to forecast available inventories of advertisement impressions for targeting different combinations of attributes before selling them to online advertisers who, for instance, would like to target users visiting certain web pages with certain demographics, geographies, behavioral interests, as well as many other attributes. Those skilled in the art will appreciate that the present invention may be used to target any impression attributes including page attributes, user attributes, browser attributes, time attributes, and so forth. For example, a content match application may use the present invention for matching an advertisement to content of a web page. Or an application on a mobile device may use the present invention for matching an advertisement to browser attributes for a browser that may process a particular type of advertisement such as video, text, so forth.

As can be seen from the foregoing detailed description, the present invention provides an improved system and method for forecasting an inventory of online advertisement impressions for targeting user profiles by sampling in a map-reduce framework. Samples of visitor profiles may be collected and matched to targeting profiles for displaying advertisements by distributed sample mappers. Sets of samples of visitor profiles matched to the targeting profiles may be mapped and distributed to reducer servers for integrating the samples collected by sample mappers into a reduction sample set for each targeting profile. Each reducer server may integrate the sets of samples of visitor profiles matched to a targeting profile into a reduction sample set for each targeting profile, and a count of samples of visitor profiles matched to a targeting profile may be aggregated. The sample reducers may forecast a targeting profile inventory for each targeting profile and output the targeting profile inventory with a reduction sample set of visitor profiles. Such a system and method may accurately and efficiently forecast availability of advertisement impressions targeting a user profiles for a particular combination of targeting attributes requested by online advertisers. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A distributed computer system for forecasting an inventory of online advertising impressions, comprising:
a plurality of reducer servers that each integrates a plurality of sets of samples of visitor profiles into a reduction sample set for a different profile of attributes targeting a plurality of visitors for displaying an advertisement impression and outputs a targeting profile inventory with the reduction sample set for the different profile of attributes targeting the plurality of visitors for displaying the advertisement impression; and
a storage operably coupled to each of the plurality of reducer servers that stores the targeting profile inventory with the reduction sample set for the different profile of attributes targeting the plurality of visitors for displaying the advertisement impression.

2. The system of claim 1 further comprising a plurality of visitor profile sample processors operably coupled to each of the plurality of reducer servers that each integrates the plurality of sets of samples of visitor profiles into the reduction sample set for the different profile of attributes targeting the plurality of visitors for displaying the advertisement impression.

3. The system of claim 1 further comprising a plurality of ad targeting forecasters operably coupled to each of the plurality of visitor profile sample processors that each outputs the targeting profile inventory with the reduction sample set for the different profile of attributes targeting the plurality of visitors for displaying the advertisement impression.

4. The system of claim 1 further comprising a plurality of sample mappers operably coupled to the plurality of reducer servers that each matches the plurality of samples of visitor profiles to a plurality of profiles of attributes targeting the plurality of visitors for displaying a plurality of advertisement impressions and sends a set of samples of visitor profiles for each different profile of attributes targeting a plurality of visitors for displaying an advertisement impression to a mapped reducer server of the plurality of reducer servers for integrating the plurality of sets of samples of visitor profiles into the reduction sample set for the different profile of attributes targeting the plurality of visitors for displaying the advertisement impression.

5. The system of claim 4 further comprising a plurality of visitor profile sample collectors operably coupled to each of the plurality of sample mappers that each collects the plurality of samples of visitor profiles.

6. The system of claim 4 further comprising a plurality of ad targeting match engines operably coupled to each of the plurality of sample mappers that each matches the plurality of samples of visitor profiles to the plurality of profiles of attributes targeting the plurality of visitors for displaying a plurality of advertisement impressions.

7. The system of claim 4 further comprising a plurality of mapper stream handlers operably coupled to each of the plurality of sample mappers that each maps the set of samples of visitor profiles for each different profile of attributes targeting the plurality of visitors for displaying the advertisement impression to the mapped reducer server of the plurality of reducer servers and sends the set of samples of visitor profiles for each different profile of attributes targeting the plurality of visitors for displaying the advertisement impression to the mapped reducer server of the plurality of reducer servers for integrating the plurality of sets of samples of visitor profiles into the reduction sample set for the different profile of attributes targeting the plurality of visitors for displaying the advertisement impression.

8. A computer-implemented method for forecasting an inventory of online advertising impressions, comprising:
receiving a plurality of sets of samples of visitor profiles for a profile of attributes targeting a plurality of visitors for displaying an advertisement impression;
integrating the plurality of sets of samples of visitor profiles into a reduction sample set for the profile of attributes targeting the plurality of visitors for displaying the advertisement impression;
aggregating a count of a plurality of samples in the plurality of sets of samples of visitor profiles for the profile of attributes targeting the plurality of visitors for displaying the advertisement impression;
forecasting a targeting profile inventory for the profile of attributes targeting the plurality of visitors for displaying the advertisement impression; and
outputting the targeting profile inventory with the reduction sample set for the profile of attributes targeting the plurality of visitors for displaying the advertisement impression.

9. The method of claim 8 wherein outputting the targeting profile inventory with the reduction sample set for the profile of attributes targeting the plurality of visitors for displaying the advertisement impression comprises storing the targeting profile inventory with the reduction sample set for the profile of attributes targeting the plurality of visitors for displaying the advertisement impression in computer-readable storage.

10. The method of claim 8 further comprising sending from a plurality of sample mappers the plurality of sets of samples of visitor profiles for the profile of attributes targeting the plurality of visitors for displaying the advertisement impression.

11. The method of claim 8 further comprising receiving by each of a plurality of sample mappers a plurality of profiles of attributes targeting the plurality of visitors for displaying a plurality of advertisement impressions.

12. The method of claim 8 further comprising collecting by each of a plurality of sample mappers a plurality of samples of visitor profiles.

13. The method of claim 8 further comprising matching by each of a plurality of sample mappers a plurality of samples of visitor profiles to a plurality of profiles of attributes targeting a plurality of visitors for displaying a plurality of advertisement impressions.

14. The method of claim 8 further comprising mapping by each of a plurality of sample mappers a plurality of profiles of attributes targeting a plurality of visitors for displaying a plurality of advertisement impressions to a plurality of reducer servers.

15. The method of claim 8 wherein integrating the plurality of sets of samples of visitor profiles into the reduction sample set for the profile of attributes targeting the plurality of visitors for displaying the advertisement impression comprises uniformly selecting a plurality of random samples from each of the plurality of sets of samples of visitor profiles and from the reduction sample set as each of the plurality of sets of samples of visitor profiles is received.

16. The method of claim 16 further comprising replacing the plurality of samples in the reduction sample set as each of the plurality of sets of samples of visitor profiles is received with the uniformly selected plurality of random samples from each of the plurality of sets of samples of visitor profiles and from the reduction sample set.

17. A computer-readable medium having computer-executable instructions for performing the method of claim 8.

18. A distributed computer system for forecasting an inventory of online advertising impressions, comprising:
means for receiving a plurality of sets of samples of visitor profiles for a profile of attributes targeting a plurality of visitors for displaying an advertisement impression;
means for integrating the plurality of sets of samples of visitor profiles into a reduction sample set for the profile of attributes targeting the plurality of visitors for displaying the advertisement impression;
means for forecasting a targeting profile inventory for the profile of attributes targeting the plurality of visitors for displaying the advertisement impression; and
means for outputting the targeting profile inventory with the reduction sample set for the profile of attributes targeting the plurality of visitors for displaying the advertisement impression.

19. The method of claim 18 further comprising:
means for collecting a plurality of samples of visitor profiles;
means for matching the plurality of samples of visitor profiles to a plurality of profiles of attributes targeting a plurality of visitors for displaying a plurality of advertisement impressions; and
means for sending the plurality of sets of samples of visitor profiles for the plurality of profiles of attributes targeting the plurality of visitors to integrate each of the plurality of sets of samples of visitor profiles matched to a different profile of attributes targeting the plurality of visitors into a reduction sample set for the different profile of attributes targeting the plurality of visitors for displaying the advertisement impression.

20. The method of claim 18 wherein means for integrating the plurality of sets of samples of visitor profiles into a reduction sample set for the profile of attributes targeting the plurality of visitors for displaying the advertisement impression comprises means for uniformly selecting a plurality of random samples from each of the plurality of sets of samples of visitor profiles for generating the reduction sample set.
